(19) United States
(12) Patent Application Publication
(10) Pub. No.: US 2003/0123947 A1
(43) Pub. Date: Jul. 3, 2003

(54) Blind rivet with hollow head

(76) Inventor: Soheil Eshraghi, Irvine, CA (US)

Correspondence Address: Trexler, Bushnell, Giangiorgi,, Blackstone & Marr, Ltd., 36th Floor, 105 West Adams Street, Chicago, IL, 60603, US

(21) Appl. No.: 10/034,434

(22) Filed: Dec. 27, 2001

(51) Int. Cl. F16B 13/04

(52) U.S. Cl. 411/43

(57) ABSTRACT

The present invention provides a fastener for securing workpieces together which has a stem having an enlarged head at one end thereof that has a cavity therethrough, a main sleeve and an expander sleeve. The expander sleeve is adapted to move into a bore of the main sleeve to radially expand the main sleeve to form a first blind head for clamping the workpieces together in response to a first axial force. The enlarged stem head is adapted to move, without any deformation thereto, into a bore of the expander sleeve to radially expand the expander sleeve to form a second blind head to further clamp the workpieces together in response to a second axial force. The fastener further has a breakneck groove on the stem adapted to fracture the stem in response to a third axial force.

### BACKGROUND OF THE INVENTION

The present invention relates to a novel blind fastener.

Blind fasteners are fasteners which are applied from one side of a pair of workpieces, such as an aircraft frame, construction members, or the like. Examples of blind fasteners are shown, for example, in U.S. Pat. Nos. 3,369,289; 4,863,325 and 6,077,009. Numerous types and configurations of blind fasteners exist.

Typically, the blind fastener is inserted from an access side of such workpieces, and, by means of a manual or power operated setting tool, is caused to be secured firmly in place. Blind fasteners have been very useful in the manufacture of various different articles and machines, such that today millions of such devices are manufactured and used.

As millions of these fasteners are made by companies around the world, it would be beneficial to have a fastener which uses less material than the other fasteners currently on the market, but which maintains all of the structural and mechanical properties of the other fasteners currently on the market. In addition, with regard to aircraft frames, weight is also a significant consideration.

The present invention provides such a fastener, as will herein be explained, which maintains all of the structural and mechanical properties desired, but which also reduces the amount of material and, thus, the weight of the fastener. Other features and advantages of the present invention will become apparent upon a reading of the specification in combination with a study of the drawings.

### OBJECTS AND SUMMARY OF THE INVENTION

A primary object of the invention is to provide a fastener having a cavity formed in a stem thereof which minimizes the weight of the stem, as well as the amount of material used, while maintaining the desired mechanical and structural properties of the fastener.

Another object of the invention is to provide a fastener having a cavity formed in a stem thereof which does not cause the stem to substantially, if at all, deform during a fastening process.

Yet another object of the invention is to provide a fastener having a cavity formed in a stem thereof such as to reduce the cost of making the fastener.

Briefly, and in accordance with the foregoing, the present invention provides a novel blind fastener for securing workpieces having aligned bores therethrough together. The blind fastener has a stem having an enlarged head at one end thereof that has a cavity therethrough, a main sleeve and an expander sleeve. The expander sleeve is adapted to move into a bore of the main sleeve to radially expand the main sleeve to form a first blind head for clamping the workpieces together in response to a first axial force supplied to the fastener by an installation tool. The enlarged stem head is adapted to move, without any deformation thereto, into a bore of the expander sleeve to radially expand the expander sleeve to form a second blind head to further clamp the workpieces together in response to a second axial force supplied to the fastener by the installation tool. The fastener further has a breakneck groove on the stem adapted to fracture the stem in response to a third axial force supplied to the fastener by the installation tool.

### BRIEF DESCRIPTION OF THE DRAWINGS

The features of the present invention which are believed to be novel are described in detail hereinbelow. The organization and manner of the structure and operation of the invention, together with further objects and advantages thereof, may best be understood by reference to the following description taken in connection with the accompanying drawings wherein like reference numerals identify like elements in which:

FIG. 1a is a side elevational, cross-sectional view of the blind fastener of the present invention including a stem member shown partly broken away, a main sleeve, an expander sleeve, lock ring and drive washer as initially assembled to workpieces to be fastened together;

FIG. 1b is a side elevational, cross-sectional view depicting the fastener of FIG. 1a at the completion stage of the installation of the workpieces from the start condition of FIG. 1a;

FIG. 2 is a side elevational, cross-sectional view of the main sleeve of the fastener; and

FIG. 3 is a side elevational, cross-sectional view of the expander sleeve of the fastener.

### DETAILED DESCRIPTION OF THE ILLUSTRATED EMBODIMENTS

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

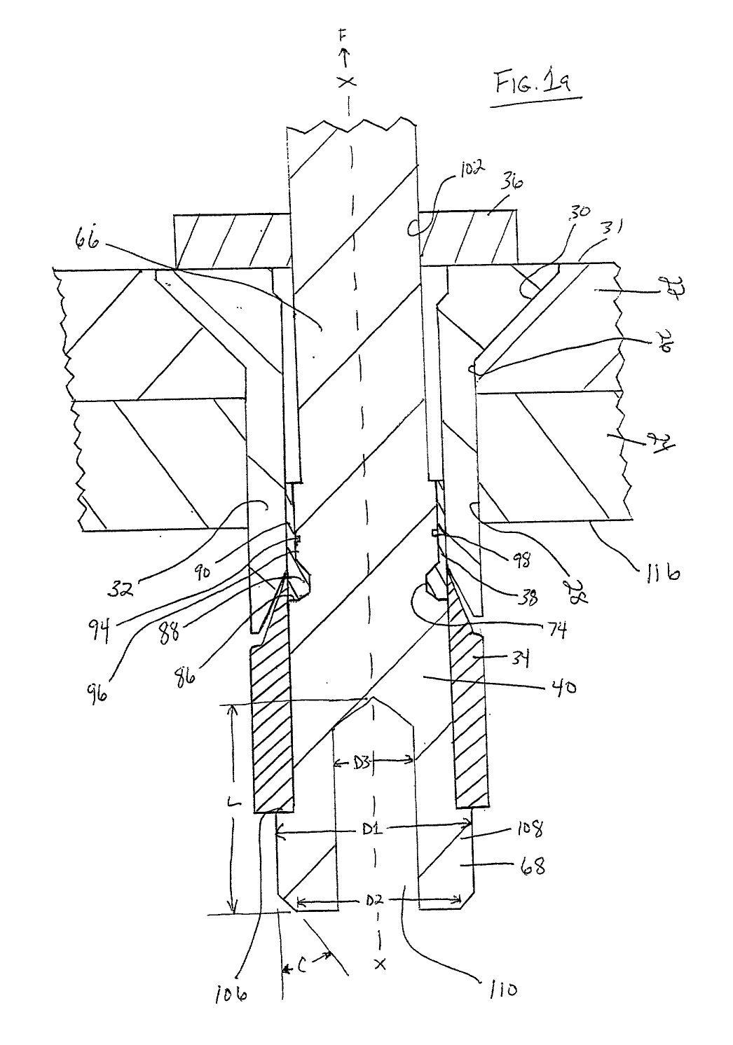

The fastener 20 as shown in FIG. 1a is adapted to secure together outer and inner workpieces 22, 24. The workpieces 22, 24 have bores 26, 28 therethrough, respectively, which are aligned with one another. The bore 26 preferably terminates at its outer end in a large diameter tapered or countersunk counterbore 30 in the outer surface 31 of the outer workpiece 22. The fastener 20 as illustrated includes a main sleeve 32, an expander sleeve 34, a drive washer 36, and a lock ring 38 supported upon a stem member 40. It is to be understood, however, that the invention is not limited to this illustrated embodiment, and may be employed with alternate designs.

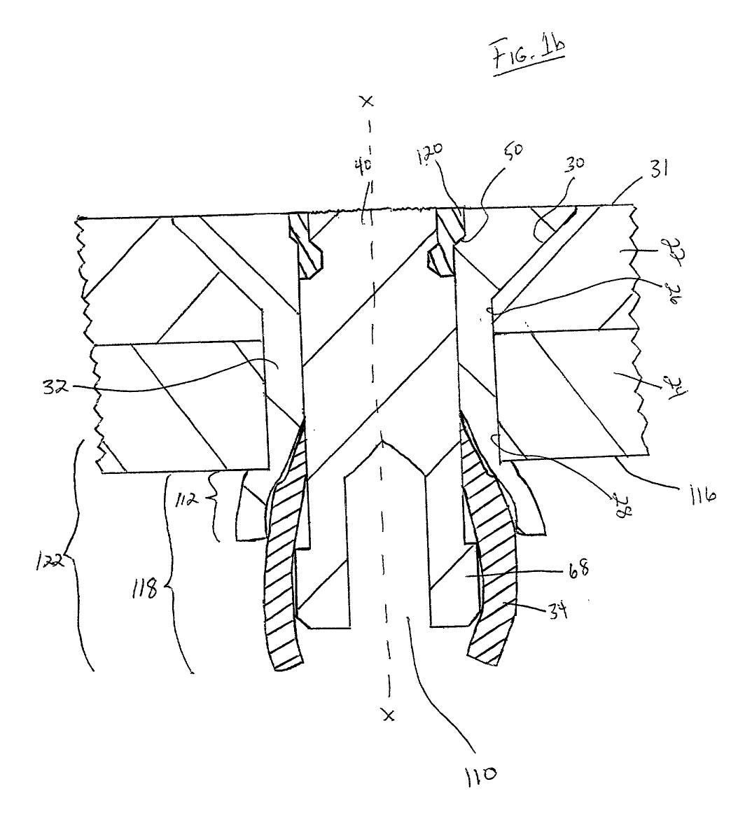

The main sleeve 32, best illustrated in FIG. 2, is of a tubular form and has an enlarged head 42 on the outer end of a cylindrical sleeve shank 44. The enlarged head 42 is of the flush or conical type and is adapted to fit in the tapered counterbore 30 of the outer workpiece 22, see FIG. 1a. It is to be understood that the main sleeve 32 could be of the type with an enlarged protruding head. The cylindrical sleeve shank 44 terminates at its inner or blind side end in a radially expandable, blind head section 46. The cylindrical shank 44 of the main sleeve 32 is of a uniform outside diameter adapted to be received through bores 26, 28 of workpieces 22, 24, respectively. The main sleeve 32 has an internal bore 48 extending therethrough. The enlarged head 42 has an annular counterbore or recess 50 at the outer end of the bore 48 for a purpose to be described. The bore 48 at the blind head section 46 of the main sleeve 32 terminates at its inner end in a radially outwardly tapered bore segment 52 which serves a purpose to be described. The bore segment tapers at an angle A relative to a central axis X of the main sleeve 32 and hence of the fastener 20. The main sleeve 32 is preferably formed of one of the following materials: aluminum, such as aluminum 5056 alloy, precipitation-hardening stainless steel, such as A-286, alloys containing nickel and copper, better known as MONEL®—manufactured by Inco Alloys International, Inc., and alloys containing nickel, chromium and iron, better known as INCONEL®—manufactured by Inco Alloys International, Inc.

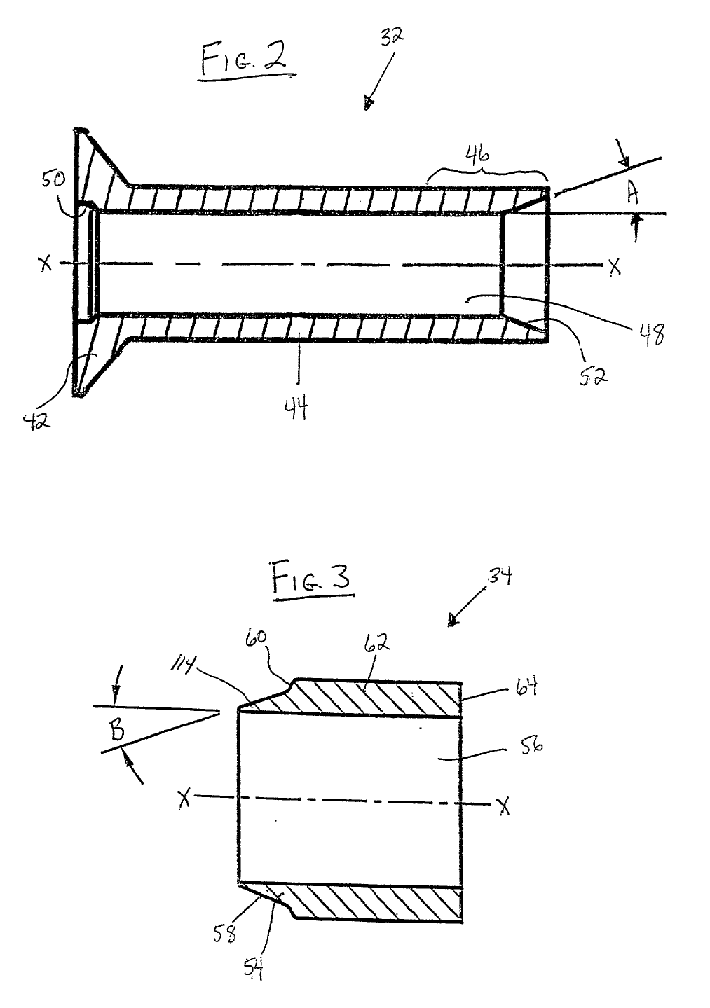

The expander sleeve 34, best illustrated in FIG. 3, is of a cylindrical form and has a tapered expansion section 54 which, as will be seen, is adapted to engage the blind head section 46 of the main sleeve 32 to form a blind head. The expander sleeve 34 has a generally uniform through bore 56 which is of a diameter generally the same as the diameter of the main sleeve bore 48. The expansion section 54 has a tapered outer surface 58 which tapers radially outwardly at an angle B relative to the central axis X of the fastener 20. The tapered outer surface 58 tapers from an outer diameter which is slightly greater than the diameter of bore 48 of main sleeve 32 to a preselected larger end diameter. The expansion section 54 further has an arcuate outer surface 60 which curves radially outwardly and then radially inwardly relative to axis X of the fastener 20. The arcuate outer surface 60 curves from the tapered outer surface 58 to a straight shank portion 62. The opposite or outer end surface 64 of the expander sleeve shank portion 62 is generally, transversely flat. The expander sleeve 34 is preferably formed of one of the following materials: precipitation-hardening stainless steel, such as A-286, 300 series stainless steel alloys, such as 304 stainless steel alloy, and 400 series stainless steel alloys, such as 400 stainless steel alloy.

As can be seen in FIG. 1a, the stem member 40 includes an elongated shank 66 and a stem head 68. The elongated shank 66 extends through the main sleeve 32 and the expander sleeve 34. The elongated shank 66 has a pulling portion (not shown) at its outer end, which is provided with a plurality of annular pull grooves (not shown) so that it can be gripped by a conventional pull type tool. Such tools are well known in the art and, therefore, the details thereof have been omitted for purposes of brevity and simplicity. The enlarged stem head 68 is provided at the blind end of the stem shank 66 and operates in a manner to be described whereby the blind head section 46 of the main sleeve 32 is expanded into an enlarged, high strength blind head as shown in FIG. 1b for clinching the workpieces 22, 24 together under a high clamp load. The stem member 40 is preferably formed of one of the following materials: precipitation-hardening stainless steel, such as A-286 or 15-7, and alloys containing nickel, chromium and iron, better known as INCONEL®—manufactured by Inco Alloys International, Inc.

An annular lock groove 74 is formed on the stem shank 66 at a distance from the stem head 68. The annular lock groove 74 is formed on the stem shank 66 within the grip range of the fastener 20 so that, upon completion of the installation after the workpieces 22, 24 have been clinched together and a blind head structure formed, the lock groove 74 is still within the enlarged sleeve head 42 of main sleeve 32. The grip range of a fastener, such as fastener 20, is the range of total thicknesses of the workpieces 22, 24 from a minimum total thickness to a maximum total thickness which it can secure together.

The lock ring 38 has a locking boss 88 of increased thickness which fits into the annular lock groove 74. A reduced thickness lock sleeve portion 90 of the lock ring 38 extends forwardly or outwardly along the stem shank 66. The lock ring 38 is of a uniform cylindrical configuration and generally conforms to the area between the shank 66 and the main sleeve 32, and is of a circumferentially open construction defined by a narrow axial slit (not shown). The open construction permits the lock ring 38 to be resiliently, radially expanded to facilitate its assembly into the lock groove 74. An enlarged, straight stem shank shoulder 86 is adapted to bear against the radially outer end of the locking boss 88 of the lock ring 38 to thereby move the lock ring 38 with the stem member 40 and, as will be seen, to apply the load to the lock ring 38 to form the front lock.

A weakened breakneck groove 94 is located on the stem shank 66 spaced outwardly from the lock groove 74. An annular land 96 is located between the lock groove 74 and the breakneck groove 94 and is of a larger diameter than the breakneck groove 94 so as to form a stem stop shoulder 98.

The stem shank 66 has a splined portion (not shown) located distal to, and between, the pulling portion and the breakneck groove 94. The splined portion is of a larger diameter than the pulling portion such as to provide an interference fit with a through bore 102 of the drive washer 36. The drive washer 36 is adapted to engage the enlarged sleeve head 42 and to react against the lock ring 38. The interference fit of the drive washer bore 102 with the splined portion holds the drive washer 36, the main sleeve 32, and the expander sleeve 34 assembled to the stem member 40 in order to facilitate handling of the fastener 20. In this regard, the splined portion is connected to the outer end of the breakneck groove 94 by a shank portion (not shown) which is of a reduced diameter so as to be able to pass through the drive washer bore 102 in clearance. In this regard, the pulling portion can also pass through the drive washer bore 102 substantially in clearance.

The enlarged stem head 68 has an enlarged diameter, axially straight head portion 108. The head portion 108, which is of a uniform diameter D1, tapers angularly, radially inwardly at its outer end, having a diameter D2, at an angle C relative to axis X of the fastener 20. The diameter D1 is preferably slightly larger than the diameter D2.

A cavity 110 is provided in the enlarged stem head 68 and extends into the stem shank 66. The cavity 110 has a uniform diameter D3 at the end of the enlarged stem head 68 and extends through the enlarged stem head 68 and into the stem shank 66 at a preselected length L. The cavity 110 tapers to a point within the stem shank 66. The diameter D3 is preferably approximately ⅗ of the diameter D2, while the length L is preferably larger than the length of the enlarged stem head 68. The cavity 110 minimizes the weight of the stem member 40 while maintaining the desired mechanical and structural properties of the fastener 20, such that the cavity 110 does not cause the stem member 40 to substantially, if at all, deform during a fastening process.

As pre-assembled, the tapered expansion section 54 of the expander sleeve 34 is adapted to nest matingly within the tapered segment 52 of the bore 48 of the main sleeve 32. At the same time, the rearward or blind end flat surface 64 of the sleeve shank portion 62 is in planar engagement with the enlarged stem head 68.

To install the fastener 20, a relative axial force “F” is applied between the stem member 40 and the expander sleeve 34 and main sleeve 32 by a pull tool which grips the pull grooves of pulling portion with the tool having an anvil member engaging the drive washer 36, as is standard in the art. The drive washer 36 at the same time transmits the load to the main sleeve 32 by its engagement with the enlarged sleeve head 42. As this occurs, the enlarged stem head 68, by engagement with the outer end surface 64, applies an axial force on the expander sleeve 34 which in turn applies an axial force on the main sleeve 32 via the tapered expansion section 54. As the load increases, the tapered expansion section 54 is moved axially into the blind head section 46 as guided by the tapered bore segment 52. This causes the blind head section 46 to be expanded radially outwardly to form a first blind head 112, see FIG. 1b. This continues until the leading end 114 of the tapered expansion section 54 is substantially at the rear or blind side surface 116 of inner workpiece 24 in order to provide the first blind head 112 with substantial strength. In this condition, the clamp load on the workpieces 22, 24 is essentially secured by the first blind head 112 at the blind side surface 116 and by the enlarged sleeve head 42 at the counterbore 30. However, the lock ring 38 is still not in position to create the lock between the stem member 40 and the main sleeve 32 at the outer or open end.

As the relative axial force is increased, the stem head 68 is moved axially inwardly past the outer end surface 64 of the shank portion 62 to form a second blind head 118, see FIG. 1b. It should be noted that a stem head shoulder 106 of the enlarged stem head 68 extends radially for a distance which is less than the wall thickness or radial length of the flat end surface 64. The limited radial length of the stem head shoulder 106 relative to the wall thickness at the end surface 64 is selected to provide sufficient resistance to movement of the stem head 68 into the expander sleeve 34 until after the first blind head 112 is substantially fully formed. This facilitates the maximization of the axial movement of the leading end 114 of the expansion section 54 into the blind head section 46 to a position proximate to the blind side surface 116 resulting in maximizing the strength of the first blind head 112 and the magnitude of final clamp load. At the same time, the wall thickness of the straight shank portion 62 is also selected to resist buckling.

The stem head 68 will be moved axially inwardly into the expander sleeve 34 until the lock sleeve portion 90 of the lock ring 38 is in engagement with the drive washer 36. As the relative axial pulling force exerted on the stem shank 66 and on the sleeve head 42 increases, the lock sleeve portion 90 is deformed radially outwardly to form an interlocking annular flange 120 in the recess 50, to firmly interlock the stem shank 66 with the main sleeve 32. At the same time, the stem stop shoulder 98 has engaged the drive washer 36. When this occurs, further relative axial force on the stem shank 66 will be resisted, causing the stem shank 66 to break at the weakened breakneck groove 94 at about the outer surface of the enlarged head 42. The locking sleeve portion 90 of the lock ring 38 initially overlaps the breakneck groove 94 sufficiently to provide for the formation of the interlocking flange 120, by the time the stem stop shoulder 98 abuts the drive washer 36.

At this point a multiple blind head assembly 122 is fully formed and includes the locking and strength interaction of the first blind head 112, the second blind head 118, the stem head 68 and the stem shank 66. The severed portion of the stem shank 66 and the drive washer 36 will be discarded.

It should be noted that after final installation upon full formation of the lock flange 120 and the fracture of the breakneck groove 94, the annular land 96 will be in line with the recess 50 in the enlarged head 42 to define a restricted cavity which cooperates with the lock groove 74 to secure the lock ring 38 and hence to positively lock the stem member 40 to the main sleeve 32 at the outer end.

During the fastening process discussed with reference to FIGS. 1a-1b, the enlarged stem head 68 and the stem shank 66 proximate to the stem head 68 do not substantially, if at all, deform or lose their shape because of the cavity 110 formed therein. The cavity 110 is of such a size and dimension, and the characteristic properties of the material used to form the stem member 40 are balanced so as to minimize the weight of the stem member 40 while maintaining the desired mechanical and structural properties of the stem member 40. The cavity 110 merely acts to reduce the weight of the stem member 40, but not at the expense of any desired mechanical or operational characteristics of the fastener 20. In other words, the cavity 110 provides no mechanical function in the fastening process.

The blind head assembly 122 has high strength resulting from the interengagement of the expander sleeve 34 within the main sleeve 32 with the leading end 114 of the expansion section 54 located very proximate to the blind side surface 116 of the inner workpiece 24. The presence of the cavity 110 does not minimize this strength in any way. The expander sleeve 34 also has high strength which assists in such high blind head assembly 122 strength as does the formation of the second blind head 118 and overengagement of the stem head 68 by the expander sleeve 34. All of the above factors contribute to forming a blind head assembly 122 having a high strength and lock.

Thus, the fastener 20 herein accomplishes positive mechanical locking of the stem member 40 to the sleeves 32, 34 without loss of clamp load and with the formation of the multiple locked blind head assembly 122 having a high strength structure which will resist deformation, even with the presence of the cavity 110.

It should further be noted that the use of the cavity 110 in the described fastener 20 can be imparted to all types of fasteners that have a stem or a pin in order to reduce the weight of the fasteners without losing any of the desired mechanical or structural properties of the fasteners.

Again, it is to be understood that the invention is not limited to this illustrated embodiment, and may be employed with alternate designs. For example, the fastener 20 can be solely used with a sleeve 32 wherein the head 68 of the fastener 20 causes the sleeve 32 to expand to lock the blind fastener with the workpieces 22, 24.

While a preferred embodiment of the present invention is shown and described, it is envisioned that those skilled in the art may devise various modifications without departing from the spirit and scope of the foregoing description.

The invention is claimed as follows:

1. A blind fastener for securing workpieces having aligned bores therethrough, said blind fastener comprising:
a stem having an elongated stem shank with an enlarged stem head at a blind end of said elongated stem shank and gripping means at an end opposite of said blind end, said enlarged stem head having a cavity provided therein;
a sleeve engaged with the workpieces and having first and second ends, an expandable section located at said second end, said sleeve having a bore therethrough and being supported on said elongated stem shank;
said enlarged stem head being adapted to move, without any deformation thereto, relative to said sleeve to deform said expandable section to form a blind head, said enlarged stem head and said cavity being dimensioned such that said enlarged stem head does not collapse during deformation of said sleeve.

2. A blind fastener as defined in claim 1, wherein said cavity provided in said enlarged stem head extends through said enlarged stem head and into said elongated stem shank.

3. A blind fastener as defined in claim 2, wherein said cavity has a diameter which is approximately ⅗ of a diameter of said enlarged stem head.

4. A blind fastener as defined in claim 2, wherein said cavity extends into said elongated stem shank a length that is only a small portion of an overall length of said stem.

5. A blind fastener as defined in claim 1, wherein said cavity has a diameter which is approximately ⅗ of a diameter of said enlarged stem head.

6. A blind fastener as defined in claim 1, wherein said stem is formed of a material selected from the group consisting of precipitation-hardening stainless steel, and alloys containing nickel, chromium and iron.

7. A blind fastener as defined in claim 1, wherein said sleeve is formed of a material selected from the group consisting of aluminum, precipitation-hardening stainless steel, alloys containing nickel and copper, and alloys containing nickel, chromium and iron.

8. A method of securing workpieces having aligned bores therethrough with a blind fastener, said method comprising the steps of:
a) providing a blind fastener including a stem having an elongated stem shank with an enlarged stem head at a blind end of said elongated stem shank and gripping means at an end opposite of said blind end, said enlarged stem head having a cavity provided therein, a sleeve having first and second ends, an expandable section located at said second end, said sleeve having a bore therethrough and being supported on said elongated stem shank;
b) inserting said blind fastener through the bores of the workpieces such that said enlarged stem head of said stem is proximate a blind surface of the workpieces and said gripping means of said stem is proximate an accessible surface of the workpieces; and
c) providing an axial force to said gripping means by an installation tool to move said stem relative to said, thereby moving said enlarged stem head into said expandable section of said sleeve to form a blind head for clamping the workpieces together without causing any deformation to said enlarged stem head, said enlarged stem head and said cavity being dimensioned such that said enlarged stem head does not collapse during deformation of said sleeve.

9. A blind fastener for securing workpieces having aligned bores therethrough, said blind fastener comprising:
a stem having an elongated stem shank with an enlarged stem head at a blind end of said elongated stem shank, gripping means at an end opposite of said blind end, and a breakneck groove on said elongated stem shank positioned between said gripping means and said enlarged stem head, said enlarged stem head having a cavity provided therein;
a main sleeve having an enlarged sleeve head located at a first end of said main sleeve, a blind head section located at a second end of said main sleeve, and a sleeve shank portion located between said enlarged sleeve head and said blind head section, said main sleeve having a bore therethrough and being supported on said elongated stem shank;
an expander sleeve having a bore therethrough and being located on said elongated stem shank between said enlarged stem head and said blind head section of said main sleeve;
said enlarged sleeve head of said main sleeve being adapted to be in engagement with an accessible side of the workpieces and said sleeve shank portion of said main sleeve being adapted to extend through the bores of the workpieces;
said expander sleeve being adapted to move into said bore of said main sleeve at said blind head section of said main sleeve to radially expand said main sleeve to form a first blind head for clamping the workpieces together in response to a first relative axial force supplied to said fastener by an installation tool adapted to grip the gripping means on said stem;
said enlarged stem head being adapted to move, without any deformation thereto, into said bore of said expander sleeve to radially expand said expander sleeve to form a second blind head to further clamp the workpieces and to secure said stem, in response to a second relative axial force supplied to said fastener by the installation tool, said enlarged stem head and said cavity being dimensioned such that said enlarged stem head does not collapse during deformation of said sleeve; and
said breakneck groove being adapted to fracture said elongated stem shank in response to a third relative axial force supplied to said fastener by the installation tool.

10. A blind fastener as defined in claim 9, wherein said stem further includes an annular lock groove on said elongated stem shank proximate to said breakneck groove and between said breakneck groove and said enlarged stem head, and an annular lock ring located in said annular lock groove and completely inside said sleeve shank portion of said main sleeve, and being axially spaced from said enlarged sleeve head of said main sleeve.

11. A blind fastener as defined in claim 10, further including a locking boss on said annular lock ring which allows said annular lock ring to move with said elongated stem shank through said bore of said main sleeve.

12. A blind fastener as defined in claim 9, wherein said cavity has a diameter which is approximately ⅗ of a diameter of said enlarged stem head.

13. A blind fastener as defined in claim 9, wherein said stem is formed of a material selected from the group consisting of precipitation-hardening stainless steel and alloys containing nickel, chromium and iron.

14. A blind fastener as defined in claim 9, wherein said main sleeve is formed of a material selected from the group consisting of aluminum, precipitation-hardening stainless steel, alloys containing nickel and copper, and alloys containing nickel, chromium and iron.

15. A blind fastener as defined in claim 9, wherein said expander sleeve is formed of a material selected from the group consisting of 300 series stainless steel alloys, 400 series stainless steel alloys, and precipitation-hardening stainless steel.
